(19) United States
(12) Patent Application Publication
(10) Pub. No.: US 2016/0224535 A1
(43) Pub. Date: Aug. 4, 2016

(54) AUTOMATED DATA CONVERSION AND PRESENTATION UTILITY

(71) Applicant: BANK OF AMERICA CORPORATION, CHARLOTTE, NC (US)

(72) Inventors: Nitin Mathur, Haryana (IN); Archana Kanodia, Uttar Pradesh (IN); Jyoti Thapa, Delhi (IN)

(21) Appl. No.: 14/609,776

(22) Filed: Jan. 30, 2015

(51) Int. Cl. G06F 17/24; G06F 3/0482

(52) U.S. Cl. CPC G06F 17/246; G06F 3/0482

(57) ABSTRACT

Automated generation of business reports and, more specifically, automatic generation of slide show presentation reports in which data presented in the reports is automatically retrieved from spreadsheet application files and inserted into appropriate locations within designated slides of the slide sheet presentation. Moreover, automatic formatting (aligning, positioning and the like) of the data inserted in the slide show presentation occurs, such that, once formatted the presentation is ready to be disseminated without further manual intervention. The automated nature of the data conversion and presentation schema eliminates much, if not all, of the manual operations typically required to generate business reports and, thus, provide greater efficiency in terms of the time required to generate the reports and eliminate errors associated with manual processing.

### FIELD

In general, embodiments of the invention relate to network data communication and, more particularly, a self-service technology-agnostic and protocol-agnostic data movement and management system implemented across all servers within an enterprise.

### BACKGROUND

In large enterprise businesses, such as financial institutions and the like, the need exists to create, on a continual basis, many different reports. Such reports, which may be generated daily, weekly, monthly, annual or the like, may be internal management reports or external/third-party reports, such as regulatory reports, auditing reports or the like.

In specific instances such reports are created in a slide show presentation application, such as Microsoft® PowerPoint®, available from Microsoft Corporation of Redmond, Wash. The information that is presented in such slide show presentations is sourced from various different electronic files. In the financial environment, the information that is presented may be sources from various spreadsheet application files (e.g., Microsoft® Excel®, available from the Microsoft Corporation of Redmond, Wash. or the like).

However, the current means for compiling such reports tends to be labor-intensive and inefficient. In most instances, users are required to manually locate the data, which may be stored in various different folders and files (i.e., source files), manually copy and paste the data items of interest from the source files to the report/slide show presentation and manually format (i.e., align and position) the updated data in the reports to ensure that the data is presentation compatible. Such manual processing is obviously time consuming and, in instances in which the reports require updating on a frequent basis (e.g., daily, weekly or the like), manual processing becomes highly impractical.

Moreover, manual processing of the reports is prone to errors, such as incorrect data, data omissions, and the like. In the business setting in which such reports include upper management financial metrics which serve as the basis for decision making, if the data presented in the reports is inaccurate, the business entity runs the risk of making unsound decisions based on the erroneous data in the report.

Therefore, a need exists to develop systems, apparatus, computer program products, and the like that eliminate the manual processing involved in generating business reports and, more specifically the manual processing of slide show presentation reports in which data presented in the reports is culled from various different electronic files, such as spreadsheet files and the like. By eliminating much, if not all, of the manual operations involved in generating business reports, the desired systems, apparatus, applications/utilities will provide greater efficiency; meaning reports can be generated in less time and as frequently as desired. In addition, the desired automated means for generating business reports should provide highly accurate, complete and up-to-date data, thereby lessening the risk of errors (i.e., inaccurate/outdated and/or incorrect data) occurring in such reports. Moreover, the desired automated means for generating business reports should be scalable, such that, reports can be replicated and customized based on the needs of the business enterprise.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, or the like for a fully automated means for generating business reports and, more specifically automatically generating slide show presentation reports in which data presented in the reports is automatically retrieved from spreadsheet application files and inserted into appropriate locations within designated slides of the slide sheet presentation. Moreover, present embodiments of the invention, provide for automatically formatting (aligning, positioning and the like) the data inserted in the slide show presentation, such that, once formatted the presentation is ready to be disseminated without further manual intervention. As such, embodiments of the present invention eliminate much, if not all, of the manual operations typically required to generate business reports and, thus, provide greater efficiency in terms of the time required to generate the reports and the frequency of which reports may be generated. In addition, the embodiments of the invention herein described provide a scalable approach that allows for dynamic customization of reports based on the needs of the business enterprise.

In specific embodiments of the invention, customized logic in the spreadsheet application files (Virtual Basic for Applications (VBA) codes, Excel® macros or the like), is relied upon for (1) copying images of a predetermined data set from a corresponding spreadsheet application file, (2) identifying locations within predetermined slides of the slide show presentation file for deletion of existing images and insertion of the copied images, (3) deleting the existing images in the identified locations within the predetermined slides of the slide show presentation file, and (4) inserting the copied images in the identified locations of the predetermined slides of the slide show presentation file. Moreover, the customized logic may be relied upon for properly positioning inserted images within designated locations of designated slides of the slide show presentation file and properly aligning margins within the designated slides so as to accommodate for dimensional differences in the inserted images.

A system for automated data conversion and presentation defines first embodiments of the invention. The system includes a distributed network including a plurality of server devices having memory that stores a plurality of folders. The folders comprise one or more spreadsheet application files that are configured for automated data conversion to a selected slide show presentation file. The system additionally includes a computing device operably connected to the distributed network and including a memory and at least one processor in communication with the memory. In addition the system includes a data conversion and presentation application that is stored in the memory and executable by the processor. The data conversion and presentation application is configured for receiving one or more first user-inputs that provides for a network path to one of the folders and receiving a second user-input that (1) based on the network path, accesses one of the servers that stores the folder, and (2) retrieves the one or more spreadsheet application files stored in the folder. Further, the data conversion and presentation application is configured for receiving a third user-input that automatically updates the slide show presentation file with pre-configured data from the one or more spreadsheet application files and, in response to updating the slide show presentation file, receiving a fourth user-input that automatically formats the slide show presentation file. Once the slide show presentation file is updated and formatted it is deemed suitable for distribution and presentation absent manual updating and formatting intervention.

In specific embodiments of the system the one or more spreadsheet application files include customized logic that is configured for (1) copying images of a predetermined data set from a corresponding spreadsheet application file, (2) identifying locations within predetermined slides of the slide show presentation file for deletion of existing images and insertion of the copied images, (3) deleting the existing images in the identified locations within the predetermined slides of the slide show presentation file, and (4) inserting the copied images in the identified locations of the predetermined slides of the slide show presentation file. In such embodiments of the system, the application is further configured for receiving the third user-input that automatically updates the slide show presentation file by (1) activate the one or more spreadsheet application files and executing the customized logic within the spreadsheet applications to (1) copy the images of the predetermined data set from the corresponding spreadsheet application file, (2) identify locations within predetermined slides of the slide show presentation file for deletion of existing images and insertion of the copied images, (3) delete the existing images in the identified locations within the predetermined slides of the slide show presentation file, and (4) insert the copied images in the identified locations of the predetermined slides of the slide show presentation file.

In further embodiments of the system, the one or more spreadsheet application files include customized logic that is configured for (1) properly positioning inserted images within designated locations of designated slides of the slide show presentation file and (2) properly aligning margins within the designated slides so as to accommodate for dimensional differences in the inserted images.

In still further embodiments of the system, the application is further configured for receiving the second user-input that (3) in response to retrieving the one or more spreadsheet application files, displays in a user-interface a network path to each of the spreadsheet application files and a code layered file name for each of the spreadsheet application files.

Moreover, in further embodiments of the system, the application is further configured to receive the third user-input that, in response to the slide show presentation file not being currently activated, displays in a user-interface a prompt that is configured to command a user to activate the slide show presentation file. Further specific embodiments of the system, the application is configured for receiving the third user-input that are configured for (1) opening and displaying a first user-interface of the one or more spreadsheet application files, and (2) displaying a second user-interface that prompts the user to activate customized logic in the one or more spreadsheet application files.

An apparatus for automated data conversion and presentation defines second embodiments of the invention. The apparatus includes a computing platform having a memory and at least one processor in communication with the memory. Further, the apparatus includes a data conversion and presentation application that is stored in the memory and executable by the processor. The application is configured for receiving one or more first user-inputs that provides for a network path to a folder that stores one or more spreadsheet application files that are configured for automated data conversion to a selected slide show presentation file and receiving a second user-input that (1) based on the network path, accesses a network server that stores the folder, and (2) retrieves one or more spreadsheet application files stored in the folder. Further, the application is configured for receiving a third user-input that automatically updates the slide show presentation file with pre-configured data from the one or more spreadsheet application files, and, in response to updating the slide show presentation file, receiving a fourth user-input that automatically formats the slide show presentation file. The resulting updated and formatted slide show presentation file is suitable for distribution and presentation absent manual updating and formatting intervention.

A computer program product including a non-transitory computer-readable medium defines third embodiments of the invention. The computer-readable medium includes a first set of codes for causing a computer to receive one or more first user-inputs that provide for a network path to a folder that stores one or more spreadsheet application files that are configured for automated data conversion to a selected slide show presentation file. Further, the computer-readable medium includes a second set of codes for causing a computer to receive a second user-input that (1) based on the network path, accesses a network server that stores the folder, and (2) retrieves one or more spreadsheet application files stored in the folder. In addition, the computer-readable medium includes a third set of codes for causing a computer to receive a third user-input that automatically updates the slide show presentation file with pre-configured data from the one or more spreadsheet application files, and a fourth set of codes for causing a computer to, in response to updating the slide show presentation file, receive a fourth user-input that automatically formats the slide show presentation file.

Thus, systems, apparatus, methods, and computer program products herein described in detail below provide for automated generation of business reports and, more specifically automatic generation of slide show presentation reports (i.e., PowerPoint® or the like) in which data presented in the reports is automatically retrieved from spreadsheet application files (Excel® files or the like) and inserted into appropriate locations within designated slides of the slide sheet presentation. Moreover, present embodiments of the invention, provide for automatically formatting (aligning, positioning and the like) the data inserted in the slide show presentation, such that, once formatted the presentation is ready to be disseminated without further manual intervention. As such, embodiments of the present invention eliminate much, if not all, of the manual operations typically required to generate business reports and, thus, provide greater efficiency in terms of the time required to generate the reports and eliminate errors associated with manual processing.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured for automatically generating slide show presentation reports in which data presented in the reports is automatically retrieved from spreadsheet application files, in accordance with embodiments of the present invention;

FIG. 2 provides a schematic diagram of a system for automated data conversion and presentation, in accordance with embodiments of the present invention;

FIG. 3 provides a flow diagram of a method for automatically generating slide show presentation reports in which data presented in the reports is automatically retrieved from spreadsheet application files, in accordance with embodiments of the present invention, in accordance with embodiments of the present invention;

FIGS. 4 and 5 provide an exemplary user-interface for receiving user-inputs that provide a network path to folders and access the folders and retrieve the files therein, display the files the names of files in the folders, and receive user-inputs that initiate the automated update of the slide show presentation, in accordance with embodiments of the present invention; and

FIGS. 6-8 provide an exemplary user-interface that displays the slide show presentation file and the spreadsheet files during the slide show presentation file update and receives a user-input for initiating the automated formatting of the updated slide show presentation file; in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for a fully automated means for generating business reports and, more specifically automatically generating slide show presentation reports in which data presented in the reports is automatically retrieved from spreadsheet application files and inserted into appropriate locations within designated slides of the slide sheet presentation. Moreover, present embodiments of the invention, provide for automatically formatting (aligning, positioning and the like) the data inserted in the slide show presentation, such that, once formatted the presentation is ready to be disseminated without further manual intervention. As such, embodiments of the present invention eliminate much, if not all, of the manual operations typically required to generate business reports and, thus, provide greater efficiency in terms of the time required to generate the reports and the frequency of which reports may be generated. In addition, the embodiments of the invention herein described provide a scalable approach that allows for dynamic customization of reports based on the needs of the business enterprise.

In specific embodiments of the invention, customized logic in the spreadsheet application files (Virtual Basic for Applications (VBA) codes, or the like), is relied upon for (1) copying images of a predetermined data set from a corresponding spreadsheet application file, (2) identifying locations within predetermined slides of the slide show presentation file for deletion of existing images and insertion of the copied images, (3) deleting the existing images in the identified locations within the predetermined slides of the slide show presentation file, and (4) inserting the copied images in the identified locations of the predetermined slides of the slide show presentation file. Moreover, the customized logic may be relied upon for properly positioning inserted images within designated locations of designated slides of the slide show presentation file and properly aligning margins within the designated slides so as to accommodate for dimensional differences in the inserted images.

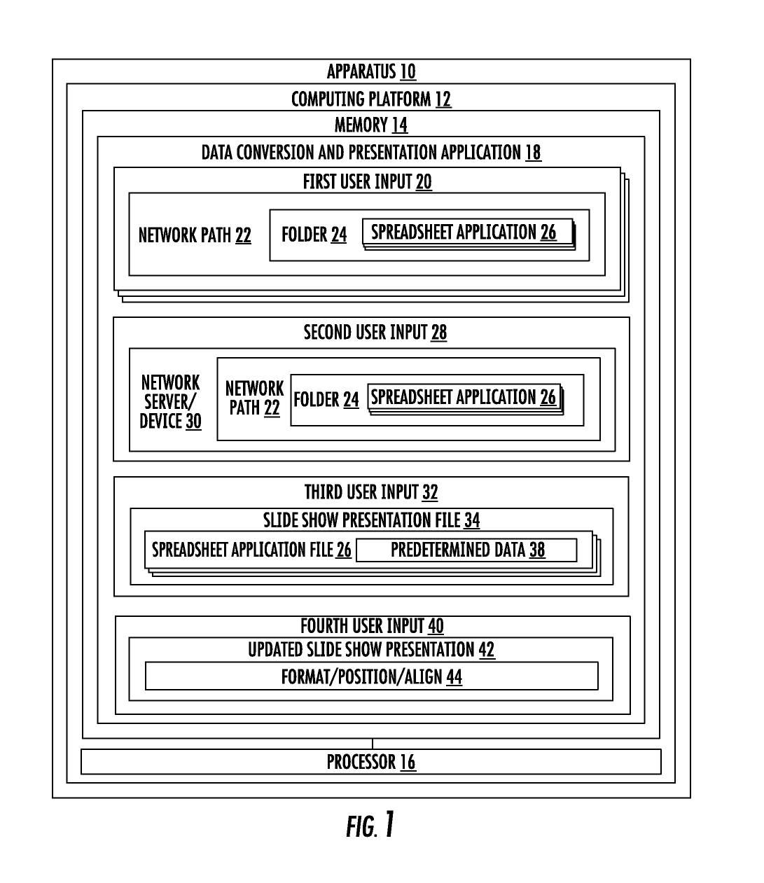

Referring to FIG. 1 a block diagram is presented of the apparatus 10, which is configured for automatically generating slide show presentation reports in which data presented in the reports is automatically retrieved from spreadsheet application files, in accordance with embodiments of the present invention. The apparatus 100 may include one or more of any type of computing device, such as a personal computer (PC), laptop computer or the like. The present apparatus and methods can accordingly be performed on any form of one or more computing devices.

The apparatus 10 includes computing platform 12 that can receive and execute algorithms, such as routines, and applications. Computing platform 12 includes memory 14, which may comprise volatile and non-volatile memory, such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk. Moreover, memory 14 may comprise cloud storage, such as provided by a cloud storage service and/or a cloud connection service.

Further, computing platform 12 also includes processor 16, which may be an application-specific integrated circuit (“ASIC”), or other chipset, processor, logic circuit, or other data processing device. Processor 16 or other processor such as ASIC may execute an application programming interface (“API”) (not shown in FIG. 1) that interfaces with any resident programs, such as data conversion and presentation application 18 and routines, sub-modules associated therewith or the like stored in the memory 14 of the apparatus 10.

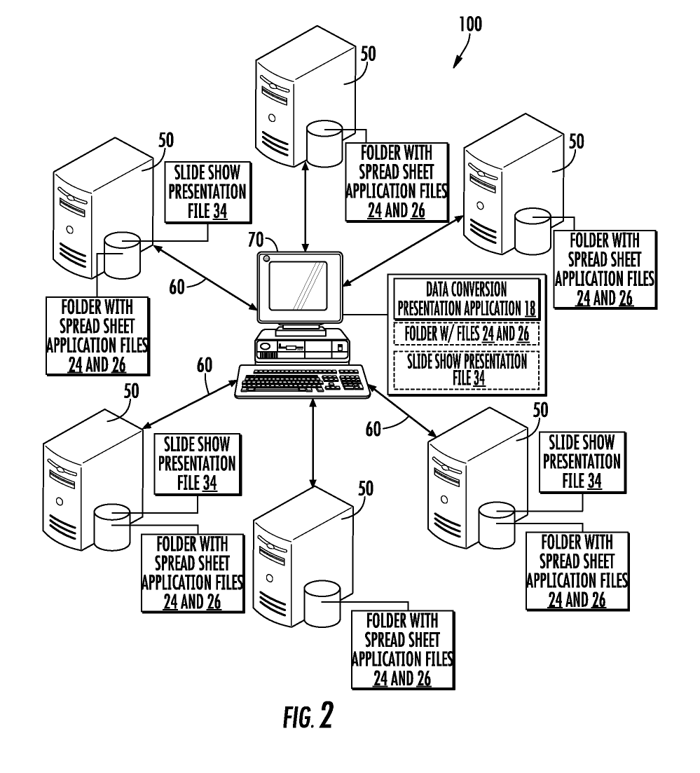

Processor 16 includes various processing subsystems (not shown in FIG. 1) embodied in hardware, firmware, software, and combinations thereof, that enable the functionality of apparatus 10 and the operability of the apparatus on a network. For example, processing subsystems allow for initiating and maintaining communications and exchanging data with other networked devices, such as network servers (50 of FIG. 2). For the disclosed aspects, processing subsystems of processor 16 may include any subsystem used in conjunction with data conversion and presentation application 18 and related algorithms, sub-algorithms, modules, sub-modules thereof.

Computer platform 12 may additionally include communications module (not shown in FIG. 1) embodied in hardware, firmware, software, and combinations thereof, that enables communications among the various components of the apparatus 10, as well as between the other networked devices. Thus, communication module may include the requisite hardware, firmware, software and/or combinations thereof for establishing and maintaining a network communication connection.

The memory 14 of apparatus 10 stores data conversion and presentation application 18 that is configured for automatically generating reports and, more specifically, automatically generating slide show presentation reports in which data presented in the reports is automatically retrieved from spreadsheet application files, in accordance with embodiments of the present invention. The data conversion and presentation application 18 is configured to receive one or more first user-inputs 20 that provide for a network path 22 (i.e., network address) to a selected folder 24 that each store one or more spreadsheet application files 26 that are configured for automated data conversion to a selected slide show presentation file. In specific embodiments the first user-input 20 may be a copy-and-paste procedure, whereby the network path 22 is copied from a designated location and pasted/inserted in an entry block of the data conversion and presentation application 18, while in other embodiments the first user-input 20 may be user manually entering a desired network path.

In specific embodiments of the invention, the spreadsheet application files 26 are configured for automated data conversion by customizing logic (i.e., Virtual Basic for Applications (VBA) codes, macros or the like) within the spreadsheet files. The customized logic will, among other functions, identify the data that is to be copied, identify the slide show presentation file, the slide within the slide show presentation and the location within the slide where the data is to be inserted, and delete existing data and insert the copied data into the identified locations within the slide show presentation slides. The customizing nature of the logic provides for scalability within the present invention, such that, functionality can be changed dynamically to provide for selecting the data to be copied from the spreadsheet, selecting an appropriate slide show presentation and inserting the copied data in the proper location of the slide show presentation.

The data conversion and presentation application 18 is additionally configured to receive a second user-input 28 that, based on the network path 22, accesses a network device/server 30 that stores the folder 24 and retrieves the one or more spreadsheet application files 26 stored in the folder 24. In specific embodiments of the invention, successful retrieval of the spreadsheet application files 26 will result in display of the file name/location in a user-interface.

Further, the data conversion and presentation application 18 is configured to receive a third user-input 32 that automatically updates the slide show presentation file 34 (previously opened/running or opened/selected in response to receiving the third user-input 32) with predetermined data 38 from the one or more spreadsheet presentation files 26. As previously noted, in specific embodiments, the spreadsheet application file includes customizing that is configured to update the slide show presentation file 34 identify the predetermined data that is to be copied, identify the slide show presentation file, the slide within the slide show presentation and the location within the slide where the data is to be inserted, and delete existing data and insert the copied data into the identified locations within the slide show presentation slides.

Moreover, the data conversion presentation application 18 is configured to receive a fourth user-input 40 that, in response to updating the slide show presentation file 34, formats, positions and aligns 44 the updated slide show presentation file 42. Such formatting 44 may include properly positioning inserted images within designated locations of the designated slides of the slide show presentation 34 and properly aligning margins within the designated slides to accommodate the dimensional differences in the inserted images.

It should be noted that while the first, second, third and fourth user-inputs are shown and described as separate and distinct user-inputs, in other embodiments of the invention, the functionality associated with two or more user-inputs may be combined in a single user-input. For example, a single user-input may be configured to both update the

Referring to FIG. 2 a schematic diagram is presented of a system 100 for automated data conversion and presentation, in accordance with embodiments of the present invention. The system includes a distributed network 60 including a plurality of server devices 50 having memory that stores a plurality of folders 24 that include one or more spreadsheet application files 26. As previously noted, in the discussion of FIG. 1, the spreadsheet application files are configured, via implementation of VBA codes or the like, to provide automated data conversion to a selected slide show presentation file. Additionally, the system 100 includes a computing device 70, which may be a PC, laptop, mobile communication device or the like that is operable commenced to the distributed network and includes a memory and at least one processor in communication with the memory.

The memory of computing device 70, which may be internal memory, network-based memory or cloud-based memory, stores data conversion and presentation application 18 that is configured to receive one or more first user-inputs that provide a network path to one of the folders 24 and receive a second user-input that, based on the network path, accesses one of the servers 50 that store the folder 24 and retrieves the one or more spreadsheet application files 26 stored in the folder. Additionally, in specific embodiments of the invention, the spreadsheet application files 26 may be stored locally on the computing device 70 or in cloud storage or the like.

Moreover, the data conversion and presentation application 18 is configured to receive third user-inputs that automatically update a selected slide show presentation file 34, which may be stored locally on the computing device 70, or externally at a network-based server device 20, or in cloud storage (not shown in FIG. 2). The update of the slide show presentation file 34 is conducted with predetermined data from the one or more spreadsheet application files 26. In addition, the data conversion and presentation application 18 is configured to receive fourth user-inputs that automatically formats (i.e., position and aligns data and margins), the slide show presentation. As a result of the automated update and formatting of the slide show presentation file, the file is ready for distribution and/or presentation absent any further manual updating or formatting intervention on behalf of the user(s).

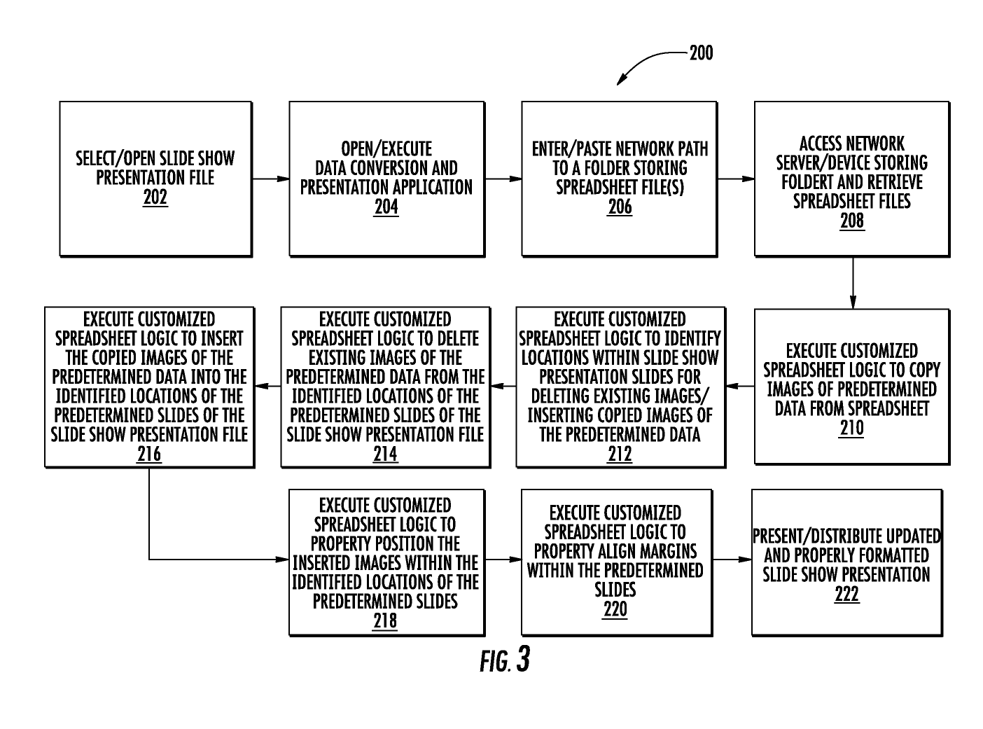

FIG. 3 provides a flow diagram of a method 200 for automatic generation of slide show presentation reports in which data presented in the reports is automatically retrieved from spreadsheet application files, in accordance with embodiments of the present invention. At Event 202 a slide show presentation file that requires creation/updating is selected and opened and, at Event 204, the data conversion and presentation application is opened/executed. In specific embodiments, the slide show presentation file is selected prior to opening/executing the data conversion and presentation application, while in other embodiments of the invention initiation of the automatic slide show presentation update/creation within the data conversion and presentation application will cause a user prompt to be displayed that asks the user to open or select from amongst more than one currently opened/executing slide show presentation, a slide show presentation file for updating.

At Event 206, a network path/address is entered or otherwise copied and pasted into an appropriately entry point within the data conversion and presentation application. The network path corresponds to the network location of a folder that stores one or more spreadsheet application files. At Event 208, the network server/device corresponding to the network path is accessed and the one or more spreadsheet files stored in the associated folder are retrieved.

At Event 210, in response to a user initiating the slide show presentation generation/update, the customized spreadsheet logic is executed to copy images of predetermined (i.e., configured/selected by user) data from the spreadsheet files and, at Event 212, the customized spreadsheet logic is further executed to identify locations within the slide show presentation (i.e., specific slides and locations within the slides) where images are to be deleted and the copied images of the predetermined data are to be inserted.

At Event 214, the customized spreadsheet logic is further executed to delete existing images of the predetermined data from the predetermined/identified slides of the slide show presentation file and, at Event 216, the customized spreadsheet logic is executed to insert the copied images of the predetermined data into the identified locations of the identified slides of the slide show presentation file.

At Event 218, automated formatting of the updated slide show presentation file occurs by executing the customized spreadsheet logic to properly position the inserted images within the identified locations of the identified slides of the slide show presentation file and, at Event 220, properly align the margins of the identified slides of the slide show presentation file.

At Event 224, based upon successful completion of the updating and formatting (i.e., positioning and alignment), the newly generated or updated slide show presentation file is presented and/or distributed without requiring any further manual updating or formatting by the user.

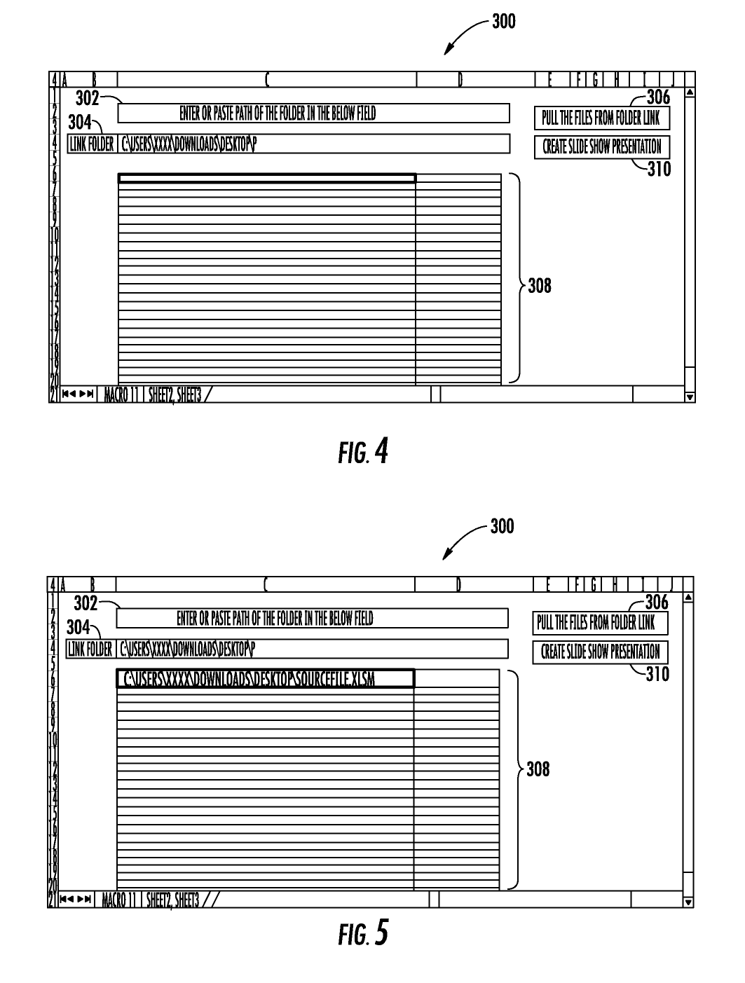

FIGS. 4-8 illustrate various examples of user interfaces displayed by a data conversion and presentation application, in accordance with embodiments of the present invention. Specifically, FIGS. 4 and 5 illustrate an example of a user-interface 300 configured for requesting automatic generation of slide show presentation reports in which data presented in the reports is automatically retrieved from spreadsheet application files, in accordance with embodiments of the invention. User-interface 300 includes instructions field 302 that instructs the user on how to paste a previously copied network path into the folder link entry field 304. Further user-interface 300 provides for user-activation key 306, which, upon user activation, accesses the network device associated with the displayed network path/folder to retrieve/pull the spreadsheet files from the linked folder. As shown in FIG. 5, once the files have been pulled/retrieved, the name is displayed in the file listing column 308. In the illustrated example of FIG. 5, the folder that has been accessed stored only one spreadsheet file and, thus, only the one file name is displayed in the file listing column 308, however; in the event that the folder stores more than one file and/or multiple folders are accessed, the file listing column 308 will list the names of multiple different files. Additionally, user-interface 300 includes user-activation key 310, which, upon user activation, is configured to initiate the generation/update of the slide show presentation file.

In the event that no slide show presentation is currently open or multiple slide show files are currently open, a prompt may be displayed (not show in FIGS. 4-8) that asks the user to open a slide show presentation file or close the slide show presentation files that are not currently requiring update.

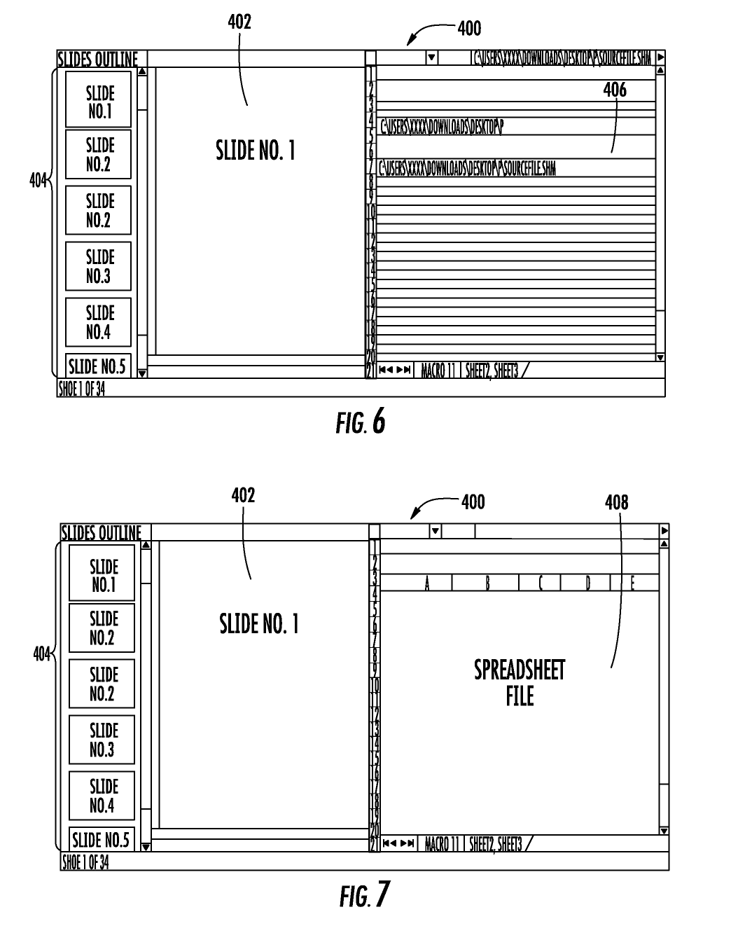

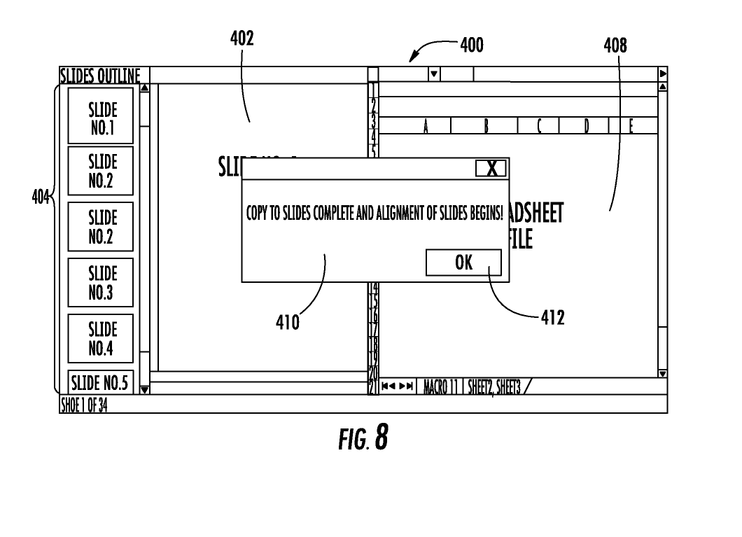

FIGS. 6-7 provide an example of user-interface 400 presented to the user during the slide show presentation update/generation process, in accordance with embodiments of the present invention. The user-interface 400 includes slide show presentation window 402 which displays an enlarged view of one of the slides of the slide show presentation (e.g., Slide No. 1) and a slide listing column 404 that displays smaller views of all of the slides of the presentation. Each of the smaller views are user-selectable with selection resulting in the display of the selected slide in the presentation window 402. Further user-interface 400 initially includes a minimized window 406 of the input user-interface shown in FIGS. 3 and 4. Once the slide show presentation updating process ensues, user-interface 400 displays a minimized window of the spreadsheet file 408 from which data is currently being copied and inserted into the slide show presentation. As shown in FIG. 8, once the data update is complete, a user prompt window 410 may be displayed which is configured to notify the user that the updating of the slide show presentation had been completed and that formatting of the updated slide show presentation is ready to be initiated. Additionally, user prompt window 410 includes user activatable key 412, which, upon user activation, initiates and completes the previously described automated formatting/alignment process.

Thus, systems, apparatus, methods, and computer program products described above provide for automated generation of business reports and, more specifically automatic generation of slide show presentation reports (i.e., PowerPoint® or the like) in which data presented in the reports is automatically retrieved from spreadsheet application files (Excel® files or the like) and inserted into appropriate locations within designated slides of the slide sheet presentation. Moreover, present embodiments of the invention, provide for automatically formatting (aligning, positioning and the like) the data inserted in the slide show presentation, such that, once formatted the presentation is ready to be disseminated without further manual intervention. As such, embodiments of the present invention eliminate much, if not all, of the manual operations typically required to generate business reports and, thus, provide greater efficiency in terms of the time required to generate the reports and eliminate errors associated with manual processing.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for automated data conversion and presentation, the system comprising:
a distributed network including a plurality of server devices having memory that stores a plurality of folders comprising one or more spreadsheet application files that are configured for automated data conversion to a selected slide show presentation file;
a computing device operably connected to the distributed network and including a memory and at least one processor in communication with the memory; and
a data conversion and presentation application stored in the memory, executable by the processor and configured for:
receiving one or more first user-inputs that provides for a network path to one of the folders;
receiving a second user-input that (1) based on the network path, accesses one of the servers that stores the folder, and (2) retrieves the one or more spreadsheet application files stored in the folder;
receiving a third user-input that automatically updates the slide show presentation file with pre-configured data from the one or more spreadsheet application files; and
in response to updating the slide show presentation file, receiving a fourth user-input that automatically formats the slide show presentation file,
wherein the updated and formatted slide show presentation file is suitable for distribution and presentation absent manual updating and formatting intervention.

2. The system of claim 1, wherein the one or more spreadsheet application files include customized logic that is configured for (1) copying images of a predetermined data set from a corresponding spreadsheet application file, (2) identifying locations within predetermined slides of the slide show presentation file for deletion of existing images and insertion of the copied images, (3) deleting the existing images in the identified locations within the predetermined slides of the slide show presentation file, and (4) inserting the copied images in the identified locations of the predetermined slides of the slide show presentation file.

3. The system of claim 2, wherein receiving the third user-input that automatically updates the slide show presentation file with the preconfigured data from the one or more spreadsheet application files further comprises receiving the third user-input that automatically updates the slide show presentation file by activating the one or more spreadsheet application files and executing the customized logic within the spreadsheet applications to (1) copy the images of the predetermined data set from the corresponding spreadsheet application file, (2) identify locations within predetermined slides of the slide show presentation file for deletion of existing images and insertion of the copied images, (3) delete the existing images in the identified locations within the predetermined slides of the slide show presentation file, and (4) insert the copied images in the identified locations of the predetermined slides of the slide show presentation file.

4. The system of claim 1, wherein the one or more spreadsheet application files include customized logic that is configured for (1) properly positioning inserted images within designated locations of designated slides of the slide show presentation file and (2) properly aligning margins within the designated slides so as to accommodate for dimensional differences in the inserted images.

5. The system of claim 1, wherein receiving the second user-input further comprises receiving the second user-input that (3) in response to retrieving the one or more spreadsheet application files, displays in a user-interface a network path to each of the spreadsheet application files and a code layered file name for each of the spreadsheet application files.

6. The system of claim 1, receiving the third user-input further comprises receiving the third user-input that, in response to the slide show presentation file not being currently activated, displays in a user-interface a prompt that is configured to command a user to activate the slide show presentation file.

7. The system of claim 1, wherein receiving the third user-input that automatically updates the slide show presentation file further comprises (1) opening and displaying a first user-interface of the one or more spreadsheet application files, and (2) displaying a second user-interface that prompts the user to activate customized logic in the one or more spreadsheet application files.

8. An apparatus for automated data conversion and presentation, the apparatus comprising:
a computing platform having a memory and at least one processor in communication with the memory; and
a data conversion and presentation application stored in the memory, executable by the processor and configured for:
receiving one or more first user-inputs that provides for a network path to a folder that stores one or more spreadsheet application files that are configured for automated data conversion to a selected slide show presentation file;
receiving a second user-input that (1) based on the network path, accesses a network server that stores the folder, and (2) retrieves one or more spreadsheet application files stored in the folder;
receiving a third user-input that automatically updates the slide show presentation file with pre-configured data from the one or more spreadsheet application files; and
in response to updating the slide show presentation file, receiving a fourth user-input that automatically formats the slide show presentation file,
wherein the updated and formatted slide show presentation file is suitable for distribution and presentation absent manual updating and formatting intervention.

9. The apparatus of claim 8, wherein the one or more spreadsheet application files are configured for automated data conversion by customizing logic within the spreadsheet application files that provide for (1) copying images of a predetermined data set from a corresponding spreadsheet application file, (2) identifying locations within predetermined slides of the slide show presentation file for deletion of existing images and insertion of the copied images, (3) deleting the existing images in the identified locations within the predetermined slides of the slide show presentation file, and (4) inserting the copied images in the identified locations of the predetermined slides of the slide show presentation file.

10. The apparatus of claim 9, wherein receiving the third user-input that automatically updates the slide show presentation file with the preconfigured data from the one or more spreadsheet application files further comprises receiving the third user-input that automatically updates the slide show presentation file by executing the customized logic within the spreadsheet applications to (1) activate the one or more spreadsheet application files, (2) copy the images of the predetermined data set from the corresponding spreadsheet application file, (3) identify locations within predetermined slides of the slide show presentation file for deletion of existing images and insertion of the copied images, (4) delete the existing images in the identified locations within the predetermined slides of the slide show presentation file, and (5) insert the copied images in the identified locations of the predetermined slides of the slide show presentation file.

11. The apparatus of claim 8, wherein receiving the fourth user-input that automatically formats the slide show presentation file further comprises receiving the fourth user-input that automatically formats the slide show presentation by customizing logic within the spreadsheet application files that provide for (1) properly positioning inserted images within designated locations of designated slides of the slide show presentation file and (2) properly aligning margins within the designated slides so as to accommodate for dimensional differences in the inserted images.

12. The apparatus of claim 8, wherein receiving the second user-input further comprises receiving the second user-input that (3) in response to retrieving the one or more spreadsheet application files, displays in a user-interface a network path to each of the spreadsheet application files and a code layered file name for each of the spreadsheet application files.

13. The apparatus of claim 8, receiving the third user-input further comprises receiving the third user-input that, in response to the slide show presentation file not being currently activated, displays in a user-interface a prompt that is configured to command a user to activate the slide show presentation file.

14. The apparatus of claim 8, wherein receiving the third user-input that automatically updates the slide show presentation file further comprises (1) opening and displaying a first user-interface of the one or more spreadsheet application files, and (2) displaying a second user-interface that prompts the user to activate customized logic in the one or more spreadsheet application files.

15. A computer program product comprising:
a non-transitory computer-readable medium comprising:
a first set of codes for causing a computer to receive one or more first user-inputs that provide for a network path to a folder that stores one or more spreadsheet application files that are configured for automated data conversion to a selected slide show presentation file;
a second set of codes for causing a computer to receive a second user-input that (1) based on the network path, accesses a network server that stores the folder, and (2) retrieves one or more spreadsheet application files stored in the folder;
a third set of codes for causing a computer to receive a third user-input that automatically updates the slide show presentation file with pre-configured data from the one or more spreadsheet application files; and
a fourth set of codes for causing a computer to, in response to updating the slide show presentation file, receive a fourth user-input that automatically formats the slide show presentation file,
wherein the updated and formatted slide show presentation file is suitable for distribution and presentation absent manual updating and formatting intervention.

16. The computer program product of claim 15, wherein the first set of codes is further configured to cause the computer to receive the first user-inputs that provide for a network path to a folder that stores one or more spreadsheet application files that include customized logic that is configured for (1) copying images of a predetermined data set from a corresponding spreadsheet application file, (2) identifying locations within predetermined slides of the slide show presentation file for deletion of existing images and insertion of the copied images, (3) deleting the existing images in the identified locations within the predetermined slides of the slide show presentation file, and (4) inserting the copied images in the identified locations of the predetermined slides of the slide show presentation file.

17. The computer program product of claim 16, wherein the third set of codes is further configured to cause the computer to receive the third user-input that automatically updates the slide show presentation file by executing the customized logic within the spreadsheet applications to (1) activate the one or more spreadsheet application files, (2) copy the images of the predetermined data set from the corresponding spreadsheet application file, (3) identify locations within predetermined slides of the slide show presentation file for deletion of existing images and insertion of the copied images, (4) delete the existing images in the identified locations within the predetermined slides of the slide show presentation file, and (5) insert the copied images in the identified locations of the predetermined slides of the slide show presentation file.

18. The computer program product of claim 15, wherein the first set of codes is further configured to cause the computer to receive the first user-inputs that provide for a network path to a folder that stores one or more spreadsheet application files that include customized logic that is configured for (1) properly positioning inserted images within designated locations of designated slides of the slide show presentation file and (2) properly aligning margins within the designated slides so as to accommodate for dimensional differences in the inserted images.

19. The computer program product of claim 15, wherein the second set of codes is further configured to cause the computer to receive the second user-input that (3) in response to retrieving the one or more spreadsheet application files, displays in a user-interface a network path to each of the spreadsheet application files and a code layered file name for each of the spreadsheet application files.

20. The computer program product of claim 15, wherein the third set of codes is further configured to cause the computer to receive the third user-input that, in response to the slide show presentation file not being currently activated, displays in a user-interface a prompt that is configured to command a user to activate the slide show presentation file.
